(19) United States
(12) Patent Application Publication
(10) Pub. No.: US 2005/0234229 A1
(43) Pub. Date: Oct. 20, 2005

(54) Method for the production of cellulose carbamate moulded bodies

(76) Inventors: Fritz Loth, Teltow (DE); Eckehart Schaaf, Teltow (DE); Peter Weigel, Kleinmachnow (DE); Hans-Peter Fink, Teltow (DE)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 10/515,787

(22) PCT Filed: May 9, 2003
(86) PCT No.: PCT/EP03/04879

§ 371 Date: Jun. 7, 2005

(30) Foreign Application Priority Data
May 24, 2002 (DE) 102 23 174.5

(51) Int. Cl. C08B 5/00; B27N 3/00

(52) U.S. Cl. 536/32; 264/109

(57) ABSTRACT

The invention relates to a method for the direct production of fibres, films, beads, sponges and other moulded articles made of cellulose carbamate which was obtained by conversion of cellulose with urea at increased temperature and direct dissolution of the reaction product in sodium hydroxide solution without an additional washing and cleaning operation.

The invention relates to a method for the direct production of fibres, films, beads, sponges and other moulded articles made of cellulose carbamate which was obtained by conversion of cellulose with urea at increased temperature and direct dissolution of the reaction product in sodium hydroxide solution without additional washing and cleaning operations.

Methods for the production of cellulose carbamates and shaping thereof according to wet shaping processes, mostly similar to the viscose process, have been known for a long time and have received particular attention in recent years in connection with the search for new ways for environmentally friendly production of cellulose regenerated fibres, as an alternative to the viscose process. In general, the cellulose carbamate (CC) is thereby produced as a storable product in special synthesis steps, cleaned and isolated, dissolved in diluted sodium hydroxide solutions, shaped by shaping elements in regenerating baths and if necessary converted in an alkaline manner into regenerated cellulose products.

Most methods for the production of cellulose carbamate are based on the fact that the starter cellulose is activated and subsequently heated with urea at temperatures above 130° C. and converted. The urea melts thereby and decomposes with splitting of ammonia into isocyanic acid. The isocyanic acid reacts with hydroxyl groups of the cellulose and cellulose carbamate is produced.

The production of cellulose carbamate by heating cellulose with urea was described in U.S. Pat. No. 2,129,708, the cellulose having been saturated with a solution of urea and alkali lye, pressed out, dried and heated to temperatures of 120 to 300° C. After washing out the by-products, alkali-soluble cellulose carbamates were obtained. This method was further developed in that the starter cellulose was pre-treated with sodium hydroxide solution of varying concentration and hence activated (EP 402605). The pre-treatment with liquid ammonia as activation step also leads, according to DE 196 28 277, to an increase in reactivity and to improved solubility of the reaction product, cellulose carbamate in sodium hydroxide solution.

The actual conversion of the reaction mixtures of cellulose and urea was effected in the drying cabinet or similar reactors at temperatures above 120° C. The use of organic liquids (toluene, xylene) as heat exchangers and entrainers for azeotropic drying of the reaction mixture (DE 196 35 473) has also been described. As a result, in fact noticeable improvements with respect to the heat transfer are achieved but working with these solvents, the complete removal thereof from the reaction mixture and their recovery are complex and associated with additional costs.

DE 198 35 688 teaches in turn that the activation of the cellulose is effected by alkali lye and subsequent treatment with alcohol and the conversion is implemented in an excess of melted urea. The urea acts thereby also as heat exchanger and prevents local overheating and discolouration of the product. One disadvantage of this mode of operation resides in the additional use of alcohol and in particular of methanol for the activation of the cellulose.

The simultaneous use of C₁ to C₉ alcohols with sodium hydroxide solution in order to activate the cellulose and the subsequent removal by distillation of water and alcohols before the reaction with urea at higher temperatures is described in DE 199 40 393. Despite the direct alcohol removal by distillation from the reaction apparatus, subsequent complex cleaning procedures of the cellulose carbamate are required.

All these known methods for the production of cellulose carbamate have the disadvantage in common that they are based on a plurality of very complex method steps in various technical systems and the reaction products must be cleaned subsequently by e.g. complex washing and/or distillation operations in order to remove by-products and non-converted starter materials, which makes processing of the cleaning solutions necessary.

According to WO 83/02279, in order to produce moulded articles made of cellulose carbamate, the latter is dissolved in aqueous sodium hydroxide solutions and the solutions are shaped in acidic and/or salt-containing regenerating baths. The decomposition of the cellulose carbamate products into regenerated cellulose is then effected in alkaline decomposition baths.

The production conditions of textile fibres made of cellulose carbamate are described in detail (inter alia DD 238984, DE 3271707). Other shaped products made of cellulose carbamate, such as sponges and sponge-type cloths, are known also from DE 199 10 105.

All these methods for shaping cellulose carbamate are wet shaping methods. They use cleaned, i.e. pure cellulose carbamate products which are complex to produce and dissolve them in diluted alkali into shaping solutions.

Starting from the described disadvantages of the previous methods, the object underlying the invention is to provide a method for the production of cellulose carbamate which is technically simple and economically attractive. In particular, the method steps of activation, drying, conversion, dissolution of the reaction product and its spinning are intended to be improved and the processing is intended to be simplified.

This object is achieved by the method with the features of claim 1. The further dependent claims reveal advantageous developments. The use of the method is described in claim 18.

According to the invention, a method for the production of cellulose carbamate moulded articles starting from activated cellulose or pulp is provided, which method is based on the following method steps.
a) Firstly, a mixture of activated cellulose or activated pulp and urea is produced in a mixing system with shearing treatment,
b) the mixture is dried,
c) and subsequently converted at a temperature between 120 and 180° C. into the reaction product, the cellulose carbamate.
d) The thus obtained, untreated and hence uncleaned reaction product is dissolved in diluted alkali lye,
e) the alkaline solution is filtered and/or deaerated and
f) subsequently shaped into the moulded article.

Surprisingly, the dissolution of the untreated, by-product-containing reaction product, the cellulose carbamate, proceeds without problems in diluted sodium hydroxide solution so that, according to the composition, noticeable advantages are produced relative to an intermediate washing with water or other treatment media. The shaping in the various known regenerating media and the decomposition of the shaped products in alkaline media also presents no additional problems. All known shaped products, such as fibres, films, beads, sponges and sponge-type cloths, can be produced according to the modes of operation and technologies which are inherent to them.

Preferably, the activation of the cellulose or of the pulp, which can be implemented before step a), is effected with 3 to 25%, preferably 4 to 20% alkali lye. The residual alkali content of the cellulose or of the pulp can thereby be reduced by washing and by subsequent pressing out and/or centrifuging to 0.1 to 0.5, particularly preferred to 0.15 to 0.3 mol alkali hydroxide per mol anhydroglucose. If required, the swollen alkali cellulose can be subjected to maturing in order to adjust the average polymerisation degree (DP).

Next, the moist alkali-containing cellulose together with the urea is transferred into a mixing system, the ratio of urea to anhydroglucose units is between 0.5 and 5, particularly preferred between 0.8 to 3, relative to the molecular masses. In the mixing system, intensive mixing of both components is effected with shearing. The thus obtained mixture is subsequently dried preferably by temperature and/or vacuum treatment, preferably the same system being used as for the mixing.

The reactive conversion of both components, i.e. of the the cellulose and of the urea, is effected subsequently preferably at temperatures between 125 and 150° C. The reaction time is thereby preferably between 30 and 240 min and preferably between 60 and 120 min. The reactive conversion can thereby be effected under inert gas and/or vacuum treatment.

In particular kneaders and/or intensive mixers with forced conveyance are suitable as mixing systems. It is particularly preferred thereby that the method steps a) to c), i.e. the shearing, the drying and the reactive conversion, are implemented in the same mixing system, both the kneader and the intensive mixer being able to be used. It is however also possible as an alternative that the method steps a) and b) are implemented in the intensive mixer with forced conveyance, while step c) is effected in the kneader.

The reaction product is subsequently cooled preferably to below 20° C., particularly preferred in the range −10 to +10° C.

In an advantageous development of the method, a 3 to 10, particularly preferably a 5 to 8% alkali lye is used in step d). In addition, it is possible that reinforcing fibres and/or expanding agents are added during dissolving. The reaction product dissolved in this manner is preferably subsequently filtered and degassed by means of vacuum treatment.

The final method step of shaping is effected preferably in a regenerating bath. Shaping can thereby be implemented in the manner known from the state of the art.

As further advantageous developments of the method, the moulded article can be converted in an alkaline manner into regenerated material subsequent to step e).

The method can be used for pulp in the same way as for cellulose. When using pulp, this can for example be immersed in a solution comprising 2 to 10% by weight sodium hydroxide solution and 20 to 40% by weight urea and subsequently be centrifuged and pressed out. The alkali-moist and urea-containing pulp is transferred subsequently into a kneader or intensive mixer and activated with intensive shearing, as described previously. In the same device, the mixture is dried by temperature increase and/or application of a vacuum and is converted after reaching a product temperature between 130 to 140° C. The dissolution and shaping of this cellulose carbamate in the presence of by-products and residual products from the conversion is effected in the previously described manner and has likewise proved thereby to be non-problematic.

The method according to the invention is used preferably in the production of fibres, films, beads, sponges and sponge-type cloths. This should however be regarded merely as an exemplary selection from the group of any moulded articles.

The subject according to the invention is intended to be explained in more detail with reference to the following examples, without restricting the subject to the individual embodiments.

### EXAMPLE 1

2500 g alkali cellulose with a cellulose content of 32.8% and an alkali content of 17% are washed with 25 l de-ionised water, are centrifuged and pressed out in a hydraulic press to a cellulose content of 41%. The moist alkali cellulose is kneaded at room temperature in a 5 l kneader with 600 g solid crystalline urea for 30 min. Subsequently, the temperature of the kneader is increased to 140° C. and the water which is present is withdrawn. After achieving a product temperature of 130-140° C., the mass is kneaded further for 105 min and subsequently discharged from the kneader. In order to obtain the pure CC, the dry crumbly mass is washed once with acetous water and 3 times only with de-ionised water at a liquid-to-solid ratio of 1:16, suctioned off via a frit and then dried at room temperature. This loosened and crumbly product had a nitrogen content of 2.8% and a DP (cᵤₒₓₐₘ) of 260. It was dissolved in a dissolving tank with agitation unit at −5 to +2° C. into a solution with 7.5% cellulose and 7.5% sodium hydroxide solution, the solution was filtered, deaerated under vacuum and spun in a spinning bath comprising 10% sulphuric acid and 17% sodium sulphate of 25° C. into filament yarns with 40 capillaries, washed and dried. The obtained yarns had a strength of 17 cN/tex with an elongation of 12% in the case of a titre of 11 tex. Their nitrogen content was 2.% and their DP (cur) 255.

### EXAMPLE 2

2500 g alkali cellulose with a cellulose content of 32.8% and an alkali content of 17% are washed with 25 l de-ionised water, are centrifuged and pressed out in a hydraulic press to a cellulose content of 43%. The moist alkali cellulose is kneaded at room temperature in a 5 l kneader with 600 g solid crystalline urea for 30 min. Subsequently, the temperature of the kneader is increased to 140° C. and the water which is present is withdrawn. After achieving a product temperature of 130-140° C., the mass is kneaded further for 105 min and subsequently discharged from the kneader.

The dry crumbly mass is dissolved, as described in Example 1, uncleaned at −5° C. in 8% sodium hydroxide solution. The cellulose carbamate content was 8.6%. The CC in the solution had a nitrogen content of 2.6%. This solution is filtered and deaerated and spun in a spinning bath comprising 8% sulphuric acid and 15% sodium sulphate of 25° C. into filament yarns with 40 capillaries, washed and dried. The obtained yarns had a strength of 16 cN/tex with an elongation of 11% in the case of a titre of 11 tex. Their nitrogen content was 2.0% and their DP (_{C}) 252.

### EXAMPLE 3

648 g spruce-sulphite pulp with a DP (_{Cuoxam})=275 are immersed in a solution containing 30% urea and 6% sodium hydroxide solution for 60 min, are centrifuged and pressed out to a cellulose content of 42%. The mass is introduced into a 5 l kneader and dried at 140° C. and converted after reaching a product temperature above 130° C. for 105 min. The dissolution of the carbamate and its shaping was effected as in Example 2. The spinning bath contained 8% sulphuric acid, 12% sodium sulphate and 4% ammonium sulphate. It had a temperature of 15° C. After a treatment in a regenerating bath of 0.5% NaOH and 12% sodium sulphate and the normal further subsequent treatment by washing and drying, the filament yarns had a nitrogen content of 0.3%, a strength of 18 cN/tex and an elongation of 9% in the case of a titre of 11 tex.

### EXAMPLE 4

The procedure was implemented as according to Example 2 and, from the untreated raw mixture, a mixture of cellulose carbamate solution, cotton fibres and sodium carbonate was produced at −2° C. There was thereby added to 1 part cellulose in the form of the dissolved cellulose carbamate, 0.5 parts cotton fibres and 9.3 parts Na₂CO₃.10H₂O, the particle size of the sodium carbonate being purely random. This mixture was coagulated at 100° C. for 8 hours into a sponge. The sponge was washed with water, neutralised with acid, washed again with glycerine-containing water and dried. After drying, the water absorption was determined. The sponge absorbed 115% of its dry weight of water. The nitrogen content of the porous matrix was 0.1%.

1. Method for the production of cellulose carbamate moulded bodies with the following steps:
a) production of a mixture of activates cellulose or activated pulp and urea in a mixing system with shearing treatment,
b) drying of the mixture,
c) reactive conversion at temperatures between 120 and 180° C.,
d) dissolution of the untreated reaction product in diluted alkali lye,
e) the alkaline solution is filtered and/or deaerated and
f) shaping into the moulded article.

2-18. (canceled)
